(19) United States
(12) Patent Application Publication
(10) Pub. No.: US 2006/0138234 A1
(43) Pub. Date: Jun. 29, 2006

(54) Methods and apparatus for improving direct part mark scanner performance

(76) Inventors: Eugene Joseph, Coram, NY (US); Duanfeng He, S. Setauket, NY (US); Bradley Carlson, Huntington, NY (US)

Correspondence Address: Fay Kaplun & Marcin, LLP, Suite 702, 150 Broadway, New York, NY, 10038, US

(21) Appl. No.: 11/025,884

(22) Filed: Dec. 29, 2004

(51) Int. Cl. G06K 7/10

(52) U.S. Cl. 235/454; 235/462.41

(57) ABSTRACT

Methods and apparatus for improving direct part mark dataform decoding using a scanner comprising a processing unit, an optical module and an imaging sensor with an extended dynamic range. The scanner captures data to obtain an extended dynamic range image for analysis. In one embodiment, the sensor is sensitive to more than eight bits per pixel and in other embodiments multiple exposures are taken. Further in alternate embodiments, the scanner comprises a pass-band filter that passes the light emitted by an illumination module.

### FIELD OF THE INVENTION

The invention is directed to Direct Part Mark (DPM) scanners and, more particularly to improving scanner performance using a filter and extended dynamic range images.

### BACKGROUND OF THE INVENTION

There are numerous standards for encoding numeric and other information in visual form, such as the Universal Product Codes (UPC) and/or European Article Numbers (EAN). These numeric codes allow businesses to identify products and manufactures, maintain vast inventories, and manage a wide variety of objects under a similar system and many other functions. The UPC and/or EAN of the product is printed, labeled, etched, or otherwise attached to the product as a dataform.

Dataforms are any indicia that encode numeric and other information in visual form. For example, direct part marking (DPM) is an important way to permanently mark objects for identification. For example, the automotive and aerospace industries have decided to use DPM dataforms to identify their products. In DPM, the surface of the object is modified to include dataforms, such as, for example, barcodes, two dimensional codes, etc. One exemplary method of marking is dot-peening, in which the surface of the object is impacted by a peening device, such as, for example, a stylus. Each impact creates a “crater”, and a collection of craters can be used to form patterns that represent dataforms such as a DataMatrix. The crater may also have a slightly raised rim around its circumference created by the material displaced during the peening process. Other methods to create surface profile modifications comprise laser etching, chemical etching, and electro-chemical etching.

FIG. 1 illustrates an exemplary dot-peened dataform 102. The circles represent craters on the surface of the object. The craters are arranged in an array that represents information. The dataform 102 can comprise information regarding the manufacturer, the UPC, the time, date and location of manufacture, etc. This information can be used for inventory, accountability, identification, recalls, etc.

In some DPM applications there is no intrinsic contrast at the site of the marking between the surface of the object and the dataform. Therefore, DPM scanning devices use the creation of highlights and/or shadows on the surface of the object to properly detect the dataform. Two ways to detect the dataform are to use bright field illumination and dark field illumination. Unfortunately, DPM dataforms are difficult to read due to low natural contrast, specular reflections, high background variations, ambient light and other factors.

Specular reflections occur when a self-illuminating scanner illuminates a dataform on a reflective surface, such as, for example a metallic surface. The light from the scanner reflects off the metallic surface and returns to the scanner's camera. In effect, the scanner is blinded by the specular reflection. Commonly used sensors do not have enough dynamic range to capture information around the reflection. Additionally, ambient light can interfere with the active or self illumination provided by a scanner, especially when the surface of the dataform is reflective.

Accordingly, there is a need for an improved DPM scanner that can increase the quality of the dataform image captured by the scanner and thus improve the performance of the scanner.

### SUMMARY OF THE INVENTION

The invention as described and claimed herein satisfies this and other needs, which will be apparent from the teachings herein.

A method of capturing data, implemented in accordance with the invention comprises illuminating a dataform using an illumination medium coupled to a scanner, capturing multiple exposures of the dataform using a different dynamic range for each exposure, combining at least two of the captured exposures to obtain an image with an extended dynamic range and analyzing the combined image.

An embodiment of a direct part mark scanner implemented in accordance with the invention comprises a processing unit, an optical module and an imaging sensor with an extended dynamic range. The direct part mark scanner captures data to obtain an extended dynamic range image for analysis. In some embodiments the scanner's imaging sensor comprises a data capture level greater than eight bits per pixel, while in other embodiments, the imaging sensor uses multiple exposures to obtain an image with an extended dynamic range. Multiple exposures can also be taken with a sensor with a data capture level greater than eight bits per pixel.

In another embodiment, the direct part mark scanner can further comprise an illumination medium and a pass-band filter. The illumination medium can emit near infrared illumination, and the pass-band filter passes the near infrared illumination. The pass-band filter can be positioned in front of or behind the optical module of the scanner.

Other objects and features of the invention will become apparent from the following detailed description, considering in conjunction with the accompanying drawing figures. It is understood however, that the drawings are designed solely for the purpose of illustration and not as a definition of the limits of the invention.

### BRIEF DESCRIPTION OF THE DRAWING FIGURES

The drawing figures are not to scale, are merely illustrative, and like reference numerals depict like elements throughout the several views.

FIG. 1 illustrates an exemplary DPM dataform.

FIG. 2 illustrates an exemplary data capture module implemented according to an embodiment of the invention.

FIG. 3 illustrates an exemplary orientation of a data capture module implemented in accordance with the invention.

FIG. 4 illustrates another embodiment of a scan module implemented according to another embodiment of the invention.

FIG. 5 illustrates an exemplary data capture method implemented according to an embodiment of the invention.

### DETAILED DESCRIPTION OF EXEMPLARY EMBODIMENTS

There will now be shown and described in connection with the attached drawing figures several exemplary embodiments of methods and apparatus for improving a DPM scanner's performance.

In exemplary embodiments of the invention, scanner performance is increased by improving the quality of the images captured by the scanner. Cleaner images are easier to decode, thus improved image capture leads to improved scanner performance. Additionally, if the scanner captures improved images, a less intensive faster decoding algorithm might be used to increase the operation speed of the scanner.

Specular reflections occur when the light from an illuminating medium reflects off a surface of a DPM object and “blinds” the camera, for example, the captured image can have bright spots where no dataform information can be analyzed. Extending the dynamic range of the captured images allows the scanner to capture images that decrease the effect of specular reflections, and allows the scanner to analyze more of the captured image. Exemplary methods and apparatus of capturing data, implemented in accordance with the invention, comprises achieving an extended dynamic range with the imaging sensor of the DPM scanner. One method of achieving an extended dynamic range is to combine two images taken at different exposure settings. Another method is to use a sensor that has a data capture capability greater than eight bits per pixel.

In an alternate embodiment, the performance of a DPM scanner can be improved by adding a narrow band optical filter in the lens path to limit the amount of ambient light collected by the sensor. The pass-band of the filter is matched with the wavelength of the illumination source of the scanner. When a filter utilizing an interference effect is used, slight broadening of the pass-band can be implemented to allow for incoming light that passes through the filter at different angles. The filter blocks most of the ambient light since ambient light is generally broad spectrum. Additionally, the illumination source can be visible or near infrared. Using near infrared illumination further decreases the effect of ambient light since there is little near infrared light in certain types of ambient light, such as, for example, fluorescent light and in certain LED illumination. A scanner implemented in accordance with the invention can use images with an extended dynamic range in combination with a near infrared illumination medium and a pass-band filter.

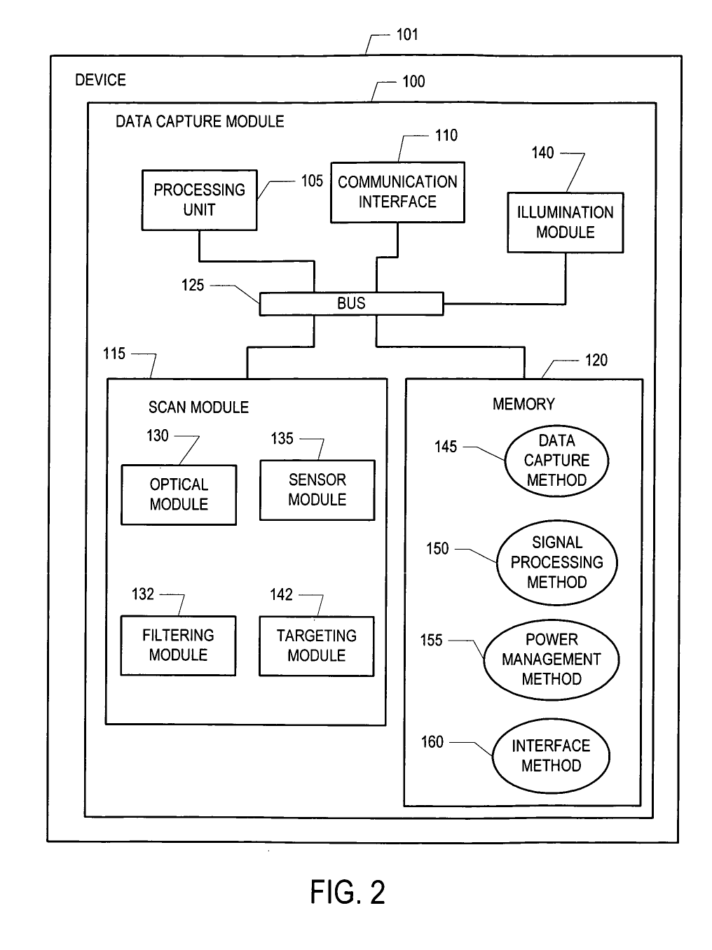

With reference to FIG. 2, there is shown an exemplary block diagram of a device 101 comprising a data capture module 100 implemented in accordance with the invention. The device 101 can be, in an exemplary embodiment, a stationary scanner, a handheld scanner, a mobile computer, etc. The data collection module 100 can be, in one non-limiting exemplary embodiment, a DPM scanner module 100. The DPM scanner module 100 can be integrated into the device 101. In addition, although the data capture module 100 is illustrated as being within device 101, in alternate embodiments, the data capture module 100 can be a separate module that is coupled to the device 101, by a wire or wirelessly. For example, in one embodiment, the data capture module 100 can be a convertible stationary/handheld scan gun coupled to a computer 101.

DPM scanner module 100 comprises processing unit 105, scan module 115, memory 120, communication interface 110 and illumination module 140 coupled together by bus 125. The modules of data capture module 100 can be implemented as any combination of software, hardware, hardware emulating software, and reprogrammable hardware. The bus 125 is an exemplary bus showing the interoperability of the different modules of the invention. As a matter of design choice there may be more than one bus and in some embodiments certain modules may be directly coupled instead of coupled to a bus 125.

Processing unit 105 can be implemented as, in exemplary embodiments, one or more Central Processing Units (CPU), Field-Programmable Gate Arrays (FPGA), etc. In an embodiment, the processing unit 105 can comprise a general purpose CPU that processes software and raw image data stored in memory 120. In other embodiments, modules of the processing unit 105 may be preprogrammed in the processing unit's 105 memory to perform functions, such as, for example, signal processing, interface emulation, etc. In alternate embodiments, one or more modules of processing unit 105 can be implemented as an FPGA that can be loaded with different processes, for example, from memory 120, and perform a plurality of functions. Processing unit 105 can comprise any combination of the processors described above.

The illumination module 140 may be implemented, in one non-limiting exemplary embodiment, as one or more light emitting diodes (LED). Other illumination mediums may be used in alternate embodiments. For example, in some embodiments, the illumination medium 140 may be a near infrared illumination source.

Scan module 115 can be implemented as, in one exemplary embodiment, a camera 115 comprising an optical module 130, a filtering module 132, a sensor module 135 and a targeting module 142. The optical module 130 can be, for example, the lens 130 of the camera 115. In some embodiments, the optical module 130 can comprise of more than one lens and/or provide more than one focus point. In addition, the optical module 130 is not limited to lenses; any prism and/or other optical medium that is suitable for capturing images can be used to implement the optical module 130. The filtering module 132 can be implemented as a band-pass filter that passes wavelengths of light matching the illumination medium 140.

The sensor module 135 can be implemented, in one exemplary embodiment, as a Charged-Coupled Device (CCD). The CCD 135 records images in digital format for processing. In alternate embodiments, any sensor that captures images can be used to implement the sensor module 135, such as, for example, CMOS semiconductor sensors. In some embodiments of the invention, the sensor has a data capture capability greater than eight bits per pixel.

Some embodiments of the invention may comprise a targeting module 142. The targeting module 142 comprises a light source or sources, for example, a laser, that projects a target approximating the field of view of the image scanner 100. The target appears on an object as a crosshair, a square, a circle, or any other design that can assist the user in placing the dataform in the field of view of the scanner.

Memory 120 can be implemented as volatile memory, non-volatile memory and rewriteable memory, such as, for example, Random Access Memory (RAM), Read Only Memory (ROM) and/or flash memory. The memory 120 stores methods and processes used to operate the image scanner 100, such as, signal processing method 150, power management method 155 and interface method 160. The memory 120 can also be used to store raw image data and/or processed image data.

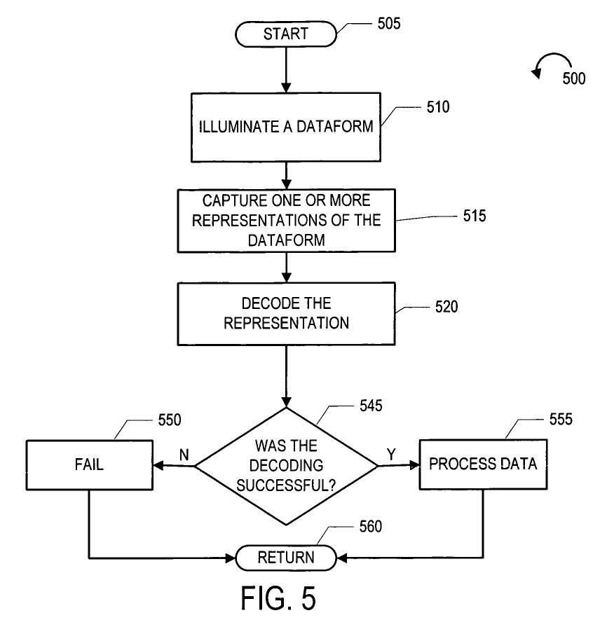

When a scanning operation is initiated, for example a trigger is depressed, the scanner 100 begins data capture method 145. An exemplary embodiment of data capture method 145 is described below with reference to FIG. 5. During the data capture method 145, scan module 115 capture images within the field of view of the scanner 100, and the images are analyzed and decoded by signal processing method 150.

Power management method 155 manages the power used by DPM scanner module 100. In some embodiments, the scanner module 100 can switch to a power save mode, when no activity is detected for a given amount of time. The power save mode can completely shut down the scanner 100 or initiate other power saving techniques.

Data collection module 100 can be implemented as a module for different devices 101 that communicate in a variety of languages. Therefore, data collection module 100 comprises an interface method 160 that translates the decoded dataform into the language of the device 101 that interfaces with the data collection module 100. Different interfaces include Universal Serial Bus (USB), scanner emulation, IBM keyboard wedge, Symbol Serial Interface (SSI), etc. Communication is performed through communication interface 110.

The exemplary embodiment of FIG. 2 illustrates data capture method 145, signal processing method 150, interface method 160 and power management method 155 as separate components, but these methods are not limited to this configuration. Each method described herein in whole or in part can be separate components or can interoperate and share operations. Additionally, although the methods are depicted in the memory 120, in alternate embodiments the methods can be incorporated permanently or dynamically in the memory of processing unit 105. In some embodiments, scan module 115 can be separate from the data capture module 100, and the data capture module 100 can be implemented using a general-purpose computer and software.

Memory 120 is illustrated as a single module in FIG. 2, but in some embodiments image scanner 100 can comprise more than one memory module. For example, the methods described above can be stored in separate memory modules.

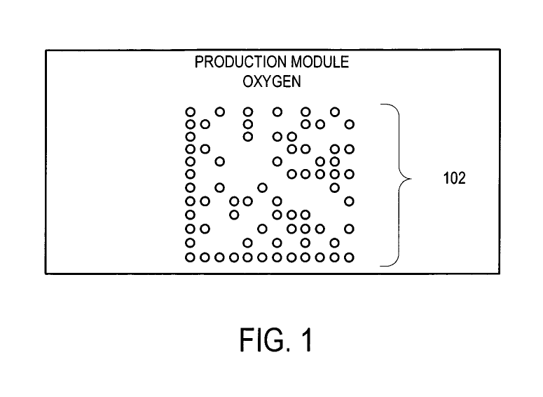

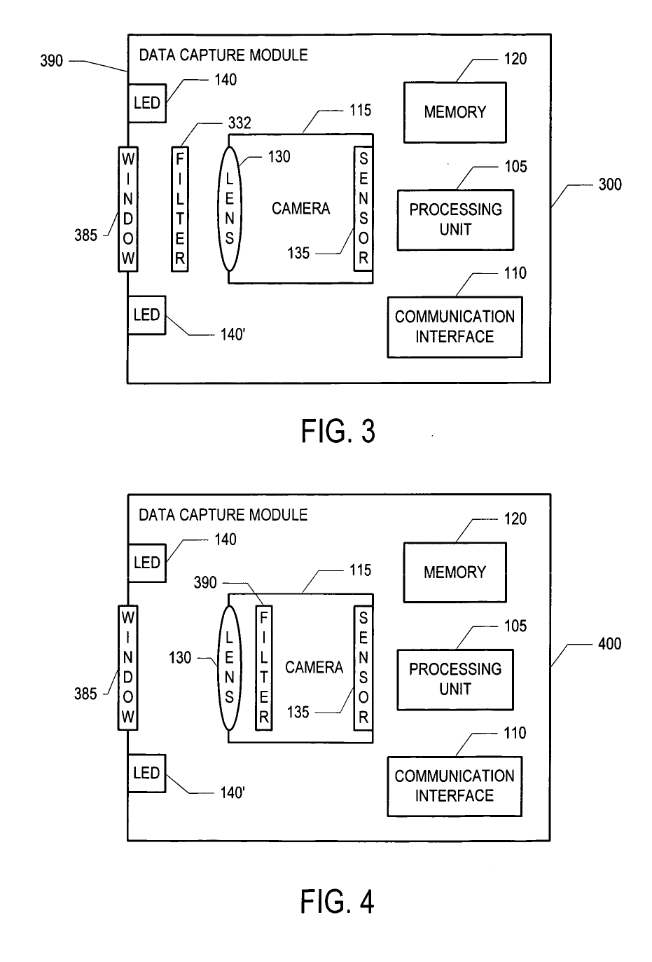

FIG. 3 illustrates an exemplary embodiment of a data capture module 300 implemented in accordance with the invention. Data capture module 300 can be implemented as a DPM scanner module 300, the scan module 115 can be implemented as a camera 115, and the illumination module 140 can be implemented as LEDs 140, 140′. As with data capture module 100 of FIG. 1, data capture module 300 additionally comprises memory 120, a processing unit 105 and communication interface 110.

An exemplary orientation of the scan module 115 and the illumination module 140 is illustrated in FIG. 3. One side 390 of the data capture module 300 is the front of the module 300, and faces the target dataform when scanning. The LEDs 140, 140′ are exposed on the front facing side 390 of the data capture module 300, and are positioned on opposite sides of an exit window 385. A pass-band filter 390 is positioned behind the window 385. The pass-band filter is designed to pass the wavelength of light emitted by the LEDs 140, 140′. Since ambient light is mostly broad spectrum, the filter blocks most of the ambient light and a cleaner image of the dataform is obtained.

A camera 115 is positioned after the filter 390. The camera 115 comprises a lens 130 and a sensor 135. The sensor 135 can be an extended dynamic range sensor or an eight-bit sensor. In either case, the camera can be programmed to take multiple images of a dataform at different exposure settings and obtain an image with an extended dynamic range from the multiple images. Additionally, in some embodiments, the exit window 385 can be replaced by the filter 390.

FIG. 4 illustrates another embodiment of a data capture module 400 implemented in accordance with the invention. Data capture module 400 can be implemented as a DPM scanner module 400. DPM scanner module 400 comprises the same elements as DPM scanner 300 of FIG. 3, except in this embodiment, the pass-band filter 390 is positioned behind the lens 130. In an alternate embodiment, the camera 115 can be placed on the outer edge of the data capture module 400 so that the lens 130 replaces the window 385.

FIG. 5 illustrates an exemplary embodiment of a method 500 for scanning dataforms. Reference to DPM scanner 100 is made in the description of method 500. The steps of method 500 and other methods described herein are exemplary and the order of the steps may be rearranged as a matter of design choice. Data capture method 500 begins with start step 505. In an exemplary embodiment, the method 500 begins when the DPM scanner 100 and/or device 101 receives power and/or when a trigger or button on the scanner 100 is pressed. The device 101 and/or DPM scanner 100 can run diagnostics prior to operation.

Processing proceeds from step 505 to step 510, where the scanner 100 illuminates a target dataform. The illumination can be visible with wavelengths, for example, between 0.4 μm and 0.7 μm or the illumination can be near infrared with wavelengths, for example, between 0.7 μm and 1.2 μm. The combination of an illumination source and a matching band-pass filter designed to pass the near infrared illumination can reduce the negative effects of ambient light on a captured dataform image.

Processing proceeds from step 510 to step 515, where the scanner 100 captures one or more representations, for example digital images, of the target dataform. As mention earlier, an extended dynamic range may be achieved by using a sensor with a higher dynamic range or by combining one or more images with different exposure settings.

Following step 515, in step 520, the obtained image is analyzed and the target dataform is decoded. In step 545, if the decoding algorithm is successful, processing proceeds to step 555, where the decoded data is further processed. For example, the data can be translated into a language that the device 101 can interpret. For example, if the image scanner 100 is attached to a computer via a USB connection, the decoded dataform is translated into a serial form, in step 555, and communicated to the device 101 through communication interface 110. Following step 555, processing of method 500 proceeds to step 560 where the method 500 returns to step 505, and the DPM scanner 100 is ready to process another dataform.

Returning to step 545, if the scanner 100 does not successfully decode the target dataform, processing proceeds to step 550. In some embodiments, the DPM scanner 100 does nothing, and returns in step 560 to step 505, but in other embodiments the scanner 100 can transmit a fail signal to the communication interface 110, and/or emit an audible fail indicator to the scanner 100 operator. The device 101 can be programmed to recognize the fail signal and alert the operator of the failure through an audible sound, and/or a message on a screen. Additionally, the scanner 100 and/or device 101 can instruct the operator to try again, hold the dataform up to the scanner 100 and/or angle the scanner and/or object in different directions.

Returning to step 550, in alternate embodiments, in response to a failed decoding attempt, the scanner 100 returns, in step 560, to step 510 and attempts to decode the dataform again. The scanner 100 can try a predetermined number of times before stopping.

While the embodiments of the invention were described for decoding dot-peened dataforms, the present invention can be used with dataforms created by other DPM techniques such as etching.

While there have been shown and described and pointed out fundamental novel features of the invention as applied to preferred embodiments thereof, it will be understood that various omissions and substitutions and changes in the form and detail of the disclosed invention may be made by those skilled in the art without departing from the spirit of the invention. It is the intention, therefore, to be limited only as indicated by the scope of the claims appended hereto.

What is claimed:

1. A method of scanning comprising:
illuminating an object using an illumination medium coupled to a scanner;
capturing multiple exposures of said object, wherein each exposure comprises a different dynamic range;
combining at least two of said captured exposures to obtain an image with an extended dynamic range; and
analyzing said combined image.

2. The method of claim 1, wherein said object comprises a dataform that is a dataform.

3. The method of claim 1, wherein said scanner further comprises:
a processing unit;
an optical module; and
an imaging sensor.

4. The method of claim 3, wherein said scanner further comprises:
an illumination medium; and
a band-pass filter having a pass-band that significantly overlaps the wavelength of the illumination medium.

5. The method of claim 4, wherein said band-pass filter is positioned in front of said optical module.

6. The method of claim 4, wherein said band-pass filter is positioned behind said optical module.

7. The method of claim 4, wherein said illumination medium emits a near infrared illumination, and said band-pass filter passes said near infrared illumination.

8. The method of claim 7, wherein said band-pass filter is slightly broadened to transmit wavelengths beyond said near infrared illumination.

9. A direct part mark scanner comprising:
a processing unit;
an optical module; and
an imaging sensor with an extended dynamic range, wherein said direct part mark scanner captures at least one image to obtain an extended dynamic range image.

10. The direct part mark scanner of claim 9, wherein said imaging sensor comprises a data capture level greater than eight bits per pixel.

11. The direct part mark scanner of claim 9, wherein said imaging sensor uses multiple exposures to obtain an image with an extended dynamic range.

12. The direct part mark scanner of claim 9, further comprising:
an illumination medium; and
a band-pass filter having a pass-band that significantly overlaps the wavelength of the illumination medium.

13. The direct part mark scanner of claim 12, wherein said band-pass filter is positioned in front of said optical module.

14. The direct part mark scanner of claim 12, wherein said band-pass filter is positioned behind said optical module.

15. The direct part mark scanner of claim 12, wherein said illumination medium emits a near infrared illumination, and said band-pass filter passes said near infrared illumination.

16. The direct part mark scanner of claim 15, wherein said band-pass filter is slightly broadened to transmit wavelengths beyond said near infrared illumination.

17. A direct part mark scanner comprising:
a processing unit;
an optical module;
an imaging sensor;
an illumination medium, wherein said illumination medium emits near infrared illumination; and
a band-pass filter wherein said band-pass filter passes said near infrared illumination.

18. The direct part mark scanner of claim 17, wherein said imaging sensor is an extended dynamic range sensor comprising a data capture level greater than eight bits per pixel, and wherein said direct part mark scanner captures at least one image to obtain an extended dynamic range image.

19. The direct part mark scanner of claim 17, wherein said band-pass filter is slightly broadened to transmit wavelengths beyond said near infrared illumination.

20. The direct part mark scanner of claim 17, wherein said band-pass filter is positioned in front of said optical module.

21. The direct part mark scanner of claim 17, wherein said band-pass filter is positioned behind said optical module.
